(19) United States
(12) Patent Application Publication
(10) Pub. No.: US 2011/0189884 A1
(43) Pub. Date: Aug. 4, 2011

(54) CABLE ASSEMBLY WITH IMPROVED TERMINATING MEANS

(75) Inventors: PING-SHENG SU, New Taipei (TW); HONG-LEI FAN, Kunshan (CN); XIAO-GANG WU, Kunshan (CN); LI-BING CHEN, Kunshan (CN)

(73) Assignee: HON HAI PRECISION INDUSTRY CO., LTD., New Taipei (TW)

(21) Appl. No.: 13/015,253

(22) Filed: Jan. 27, 2011

(30) Foreign Application Priority Data
Feb. 4, 2010 (CN) 201020302279.6

(51) Int. Cl. H01R 12/77; H01R 4/24

(52) U.S. Cl. 439/404; 439/492

(57) ABSTRACT

A cable assembly (1000) includes an insulative housing (11); a cable (14) having a plurality of wires (141) arranged in a row along a horizontal direction; a plurality of contacts (13) mounted to the insulative housing, and each of the contacts having a main portion (132), a mating portion (131) extending forwardly from the main portion and a tail portion (133) extending rearwardly from the main portion, the tail portion having a taper end inserted into a corresponding wire along an axial direction.

### BACKGROUND OF THE INVENTION

1. Field of the Invention

The present invention relates to a cable assembly, especially to a cable assembly with improved terminating means.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide terminating means for a cable assembly without soldering process.

Accordingly, to achieve above-mentioned object, a cable assembly comprises an insulative housing; a cable having a plurality of wires arranged in a row along a horizontal direction; a plurality of contacts mounted to the insulative housing, and each of the contacts having a main portion, a mating portion extending forwardly from the main portion and a tail portion extending rearwardly from the main portion, the tail portion having a taper end inserted into a corresponding wire along an axial direction.

The detailed features of the present invention will be apparent in the detailed description with appropriate reference to the accompanying drawings.

### BRIEF DESCRIPTION OF THE DRAWINGS

FIG. 1 is a perspective view of a cable assembly of a first embodiment in accordance with the present invention;

FIG. 2 is an exploded, perspective view of the cable assembly in FIG. 1;

FIG. 3 is a cross-section view of the FIG. 1 taken along a line 3-3;

FIG. 4 is a perspective view of a cable assembly of a second embodiment in accordance with the present invention;

FIG. 5 is an exploded, perspective view of the cable assembly in FIG. 4;

FIG. 6 is a cross-section view of the FIG. 4 taken along a line 6-6;

FIG. 7 is a perspective view of a cable assembly of a third embodiment in accordance with the present invention;

FIG. 8 is an exploded, perspective view of the cable assembly in FIG. 7;

FIG. 9 is similar to FIG. 8, but viewed from other direction;

FIG. 10 is a partially assembled, perspective view of the cable assembly in FIG. 7; and

FIG. 11 is a cross-section view of the FIG. 7 taken along a line 11-11.

### DETAILED DESCRIPTION OF THE INVENTION

Reference will now be made in detail to the preferred embodiment of the present invention.

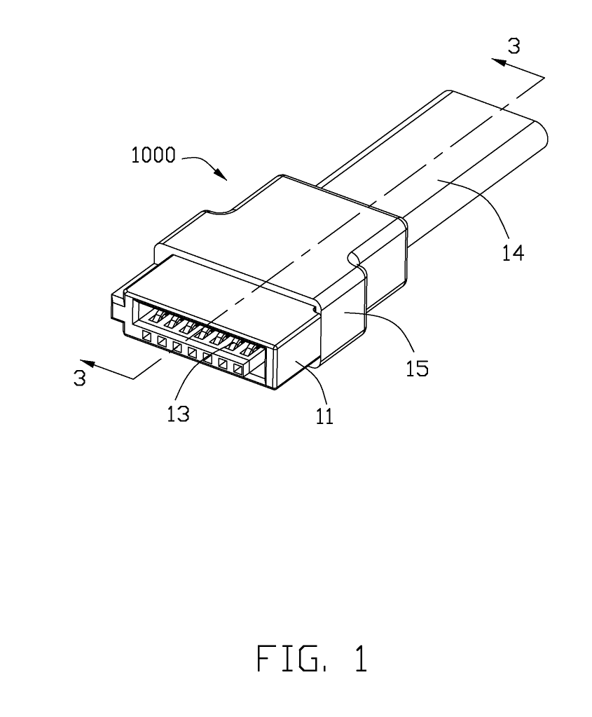

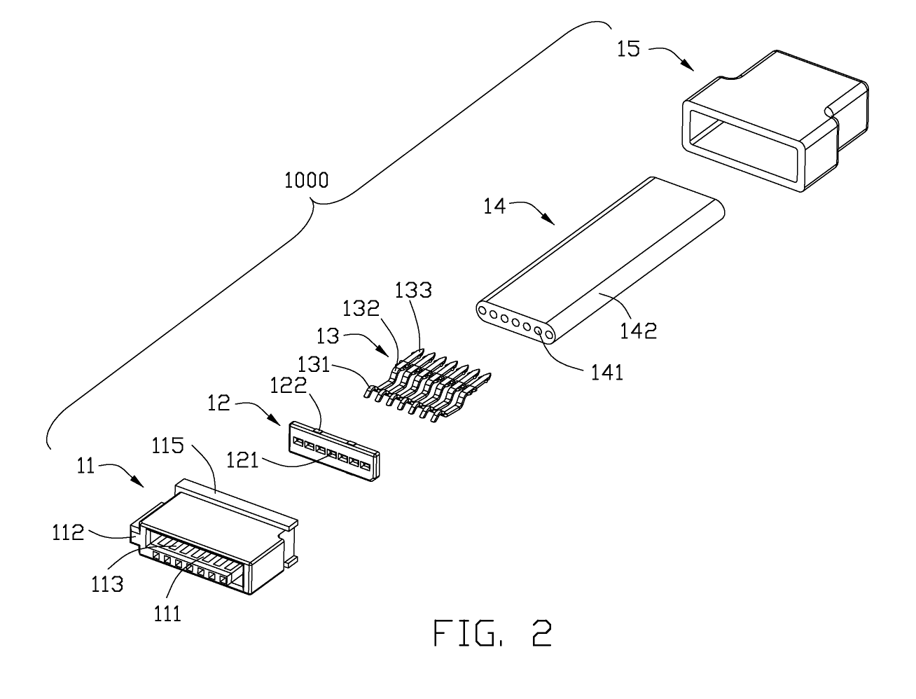

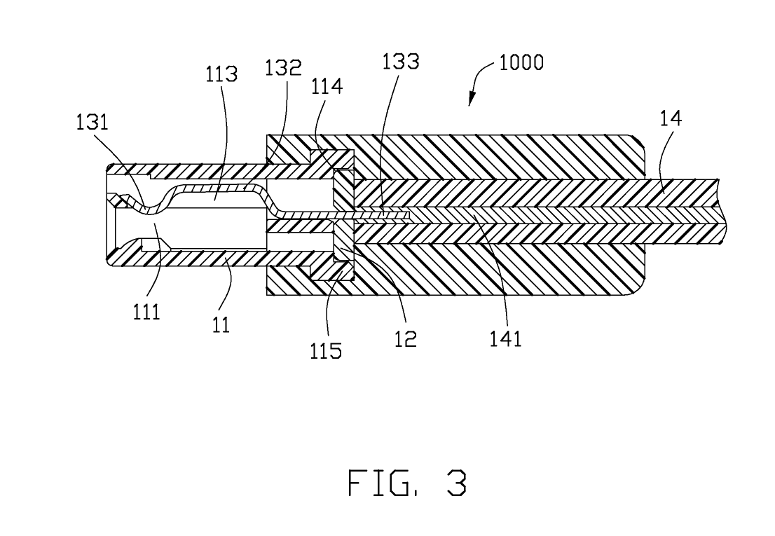

Referring to FIGS. 1-3, a cable assembly 1000 of a first embodiment in accordance with the present invention is compatible with Serial Advanced Technology Attachment (SATA). The cable assembly 1000 includes an insulative housing 11, a spacer 12, a plurality of contacts 13, a cable 14 and an outer cover 15.

The insulative housing 11 has a top wall, a bottom wall, a left wall and a right wall together defining a L-shaped mating port 111. There is a guiding rib 112 formed on the left wall. Also, a plurality of contact grooves 113 are located in the bottom wall and communicate with the mating port 111. Further, a recess 114 is defined in a back portion of the insulative housing 11 and two flanges 115 are formed on a back segment of the top wall and the bottom wall.

The spacer 12 is mounted into the recess 114. There are a plurality of through holes 121 defined in the spacer 12 and the through holes 121 are arranged in a row along a transversal direction. Two protrusions 122 are located on a top side of the spacer 112.

There are seven contacts 13 arranged in a row along the transversal direction. Three of the seven contacts 13 are grounding contacts and four of the seven contacts 13 are differential contact pairs. There are two differential contact pairs respectively disposed between the grounding contacts. Each of the seven contacts 13 includes a main portion 132, a mating portion 131 extending forwardly from the main portion 132 and a tail portion 133 extending backwardly from the main portion 132. The tail portion 133 has a taper/sharp end.

The contacts 13 are assembled to the insulative housing 11, with the main portion 132 positioned in the corresponding contact grooves 113, the mating portion 131 accommodated in the mating port 111, and the tail portion 133 passing through a corresponding through hole 121 in the spacer 12 and disposed behind the insulative housing 11. The spacer 12 is pressed into the recess 114, and the protrusions 122 can increase friction between the spacer 12 and the recess 114.

The cable 14 is a flat cable and includes a plurality of wires 141 arranged in a row along the transversal direction and an insulative jacket 142 enclosing the wires 141. The wires 141 align with the corresponding tail portions 133 along a front-to-back direction. A front end of the insulative jacket 142 and front ends of the wires 141 reach a imagery geometric plane located in a vertical direction and perpendicular to an axial direction of the cable, therefore, no other steps for proceeding the cable or wires is needed while the tail portions 133 of the contacts are inserted/penetrated into the wires 141 along the axial direction. Thus, the tail portion 133 contacting inner conductor (not shown) of the wire 141 to form electrical connection by solderless process.

The outer cover 15 is molded over a rear section of the insulative housing 11 and a front segment of the cable 14. The flanges 115 are also wrapped within the outer cover 15.

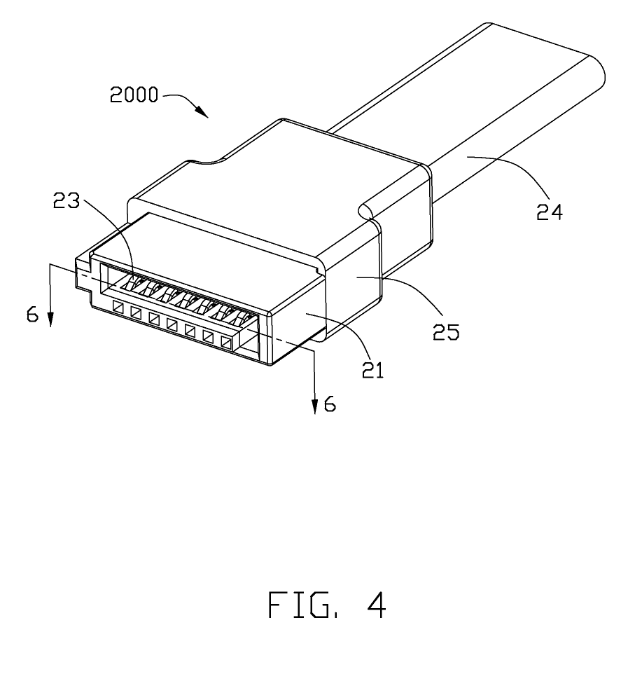

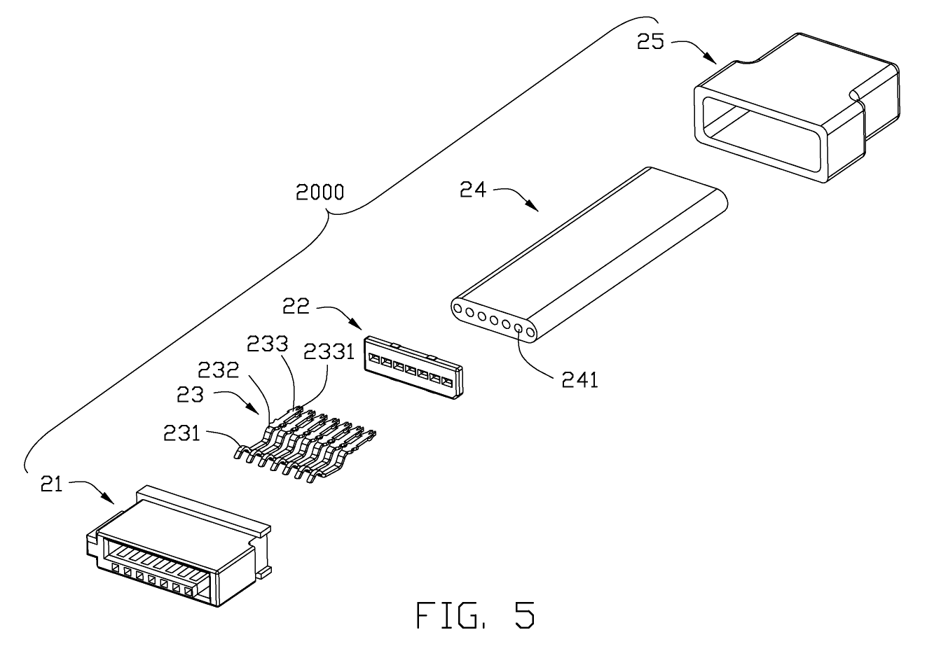

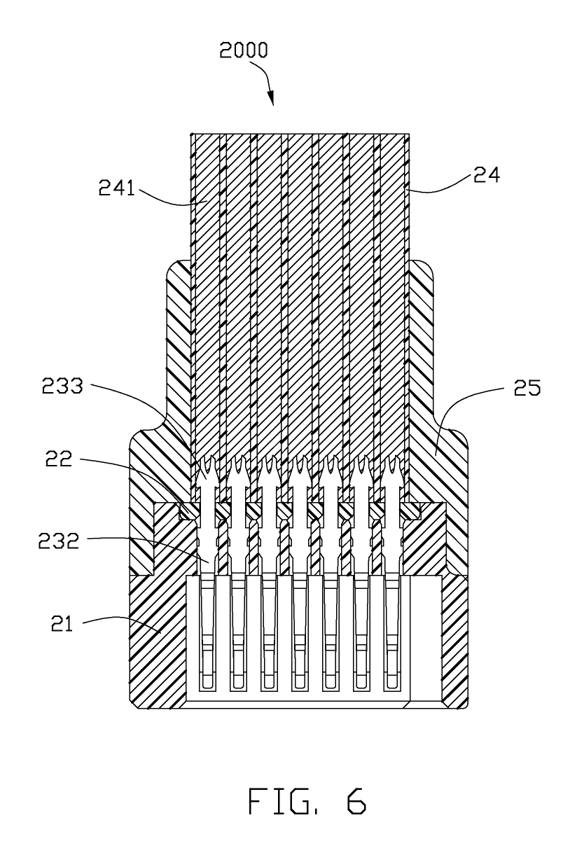

Referring to FIGS. 4-6, a cable assembly 2000 of a second embodiment in accordance with the present invention is also compatible with SATA. The cable assembly 2000 includes an insulative housing 21, a spacer 22, a plurality of contacts 23, a cable 24 and an outer cover 25. Most of aforementioned elements of the cable assembly 2000 are similar to the corresponding elements of the cable 1000, except for the contacts 23, therefore, detailed description of the same elements are omitted.

Each of the contacts 23 includes a main portion 232, a mating portion 231 extending forwardly from the main portion 232 and a tail portion 233 extending backwardly from the main portion 232. There is a triangle shaped cutout 2331 defined in the tail portion 233 and the tail portion 233 is coattail shaped with two taper/sharp ends.

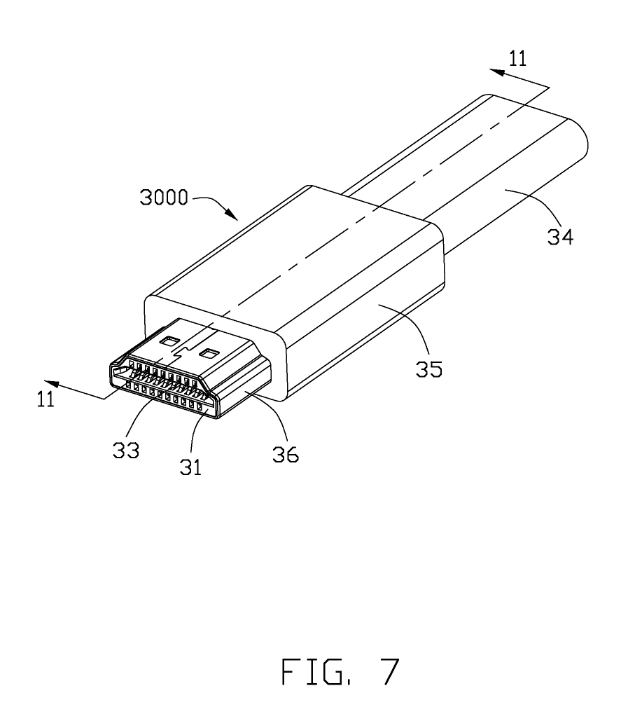

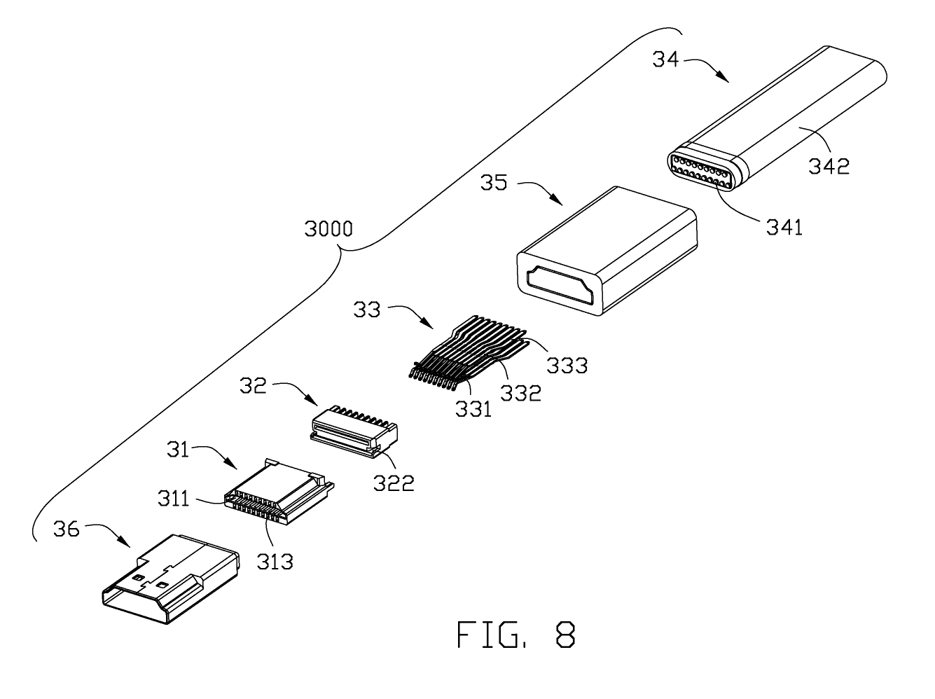

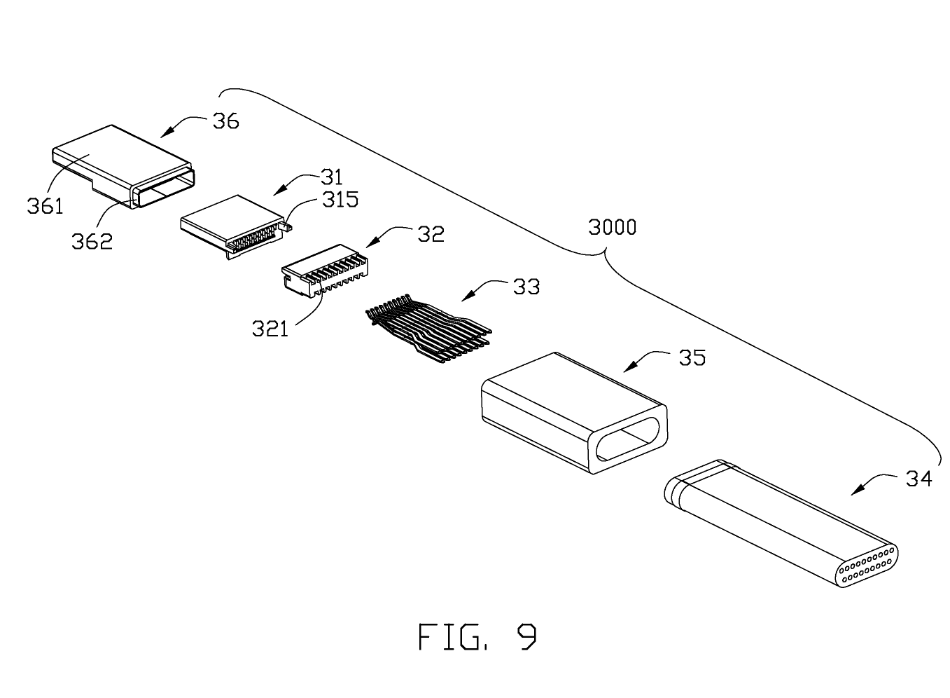

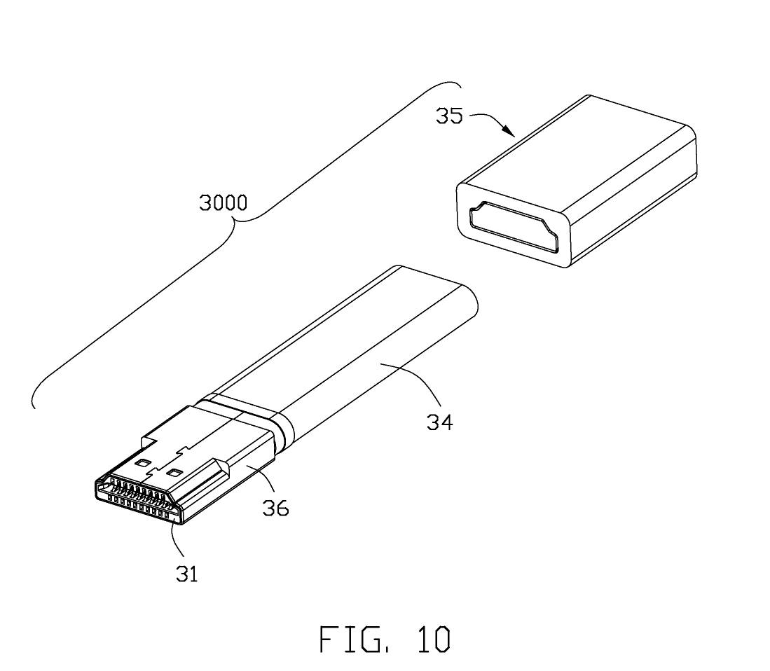

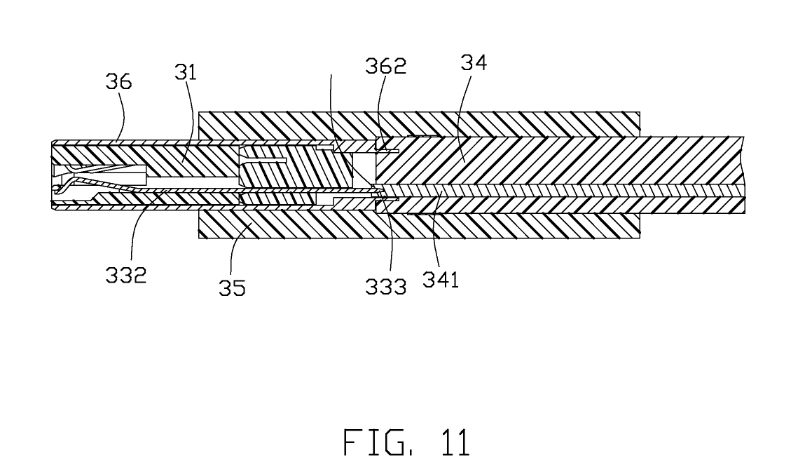

Referring to FIGS. 7-11, a cable assembly 3000 of a third embodiment in accordance with the present invention is compatible with High Definition Multimedia Interface (HDMI). The cable assembly 3000 includes an insulative housing 31, a spacer 32, a plurality of contacts 33, a cable 34, an outer cover 35 and a metallic shell 36.

The insulative housing 31 has a top wall, a bottom wall, a left wall and a right wall together defining a mating port 311. There are a plurality of contact grooves 313 located in the top wall and the bottom wall, and the contact grooves 313 also communicate with the mating port 311. Further, two posts 315 project backwardly from back edges of the left wall and the right wall.

There are a plurality of through holes 321 defined in the spacer 32 and the through holes 321 are arranged in two groups spaced apart from each other along a vertical direction. Each group of the through holes 321 arranged in a row along the transversal direction. Two slots 322 are defined in a front section of the spacer 32 to accommodate the two posts 315, respectively.

The contacts 33 are separated into two groups along the vertical direction. Each group of contacts 33 are arranged in a row along a transversal direction. Each of the contacts 33 includes a main portion 332, a mating portion 331 extending forwardly from the main portion 332 and a tail portion 333 extending backwardly from the main portion 332. The tail portion 333 has a taper/sharp end.

The contacts 33 are assembled to the insulative housing 31, with the main portion 332 positioned in the corresponding contact grooves 313, the mating portion 331 accommodated in the mating port 311, and the tail portion 333 passing through a corresponding through hole 321 in the spacer 32 and disposed behind the insulative housing 31.

The metallic shell 36 includes a hollow body portion 361 and a rectangular shaped frame 362 extending backwardly from the body portion 361. The insulative housing 31 and the spacer 32 are accommodated in the body portion 361, while the tail portions 333 are disposed in the frame 362.

The cable 34 is a flat cable and includes a plurality of wires 341 and an insulative jacket 342 enclosing the wires 341. The wires 341 are separated into two groups along the vertical direction, and each group of wires 341 are arranged in a row along the transversal direction. The wires 341 align with the corresponding tail portions 333 along the front-to-back direction. A front end of the insulative jacket 342 and front ends of the wires 341 reach same imagery geometric vertical plane perpendicular to an axial direction of the cable 34, therefore, no other steps for proceeding the cable or wires is needed while the tail portions 333 of the contacts are respectively inserted/penetrated into the wires 341. In addition, the frame 362 of the metallic shell 36 is also inserted into the insulative jacket 342.

The outer cover 35 is made of plastic material and molded over the metallic shell 36 and the insulative jacket 34.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a cable having a plurality of wires arranged in a row along a horizontal direction;
a plurality of contacts mounted to the insulative housing, and each of the contacts having a main portion, a mating portion extending forwardly from the main portion and a tail portion extending rearwardly from the main portion, the tail portion having a taper end inserted into a corresponding wire along an axial direction.

2. The cable assembly as claimed in claim 1, wherein the tail portion is coattail shaped with two taper ends.

3. The cable assembly as claimed in claim 1, wherein the cable assembly is compatible with SATA.

4. The cable assembly as claimed in claim 3, wherein the insulative housing has a top wall, a bottom wall, a left wall and a right wall together defining a L-shaped mating port.

5. The cable assembly as claimed in claim 4, wherein there are a plurality of contact grooves located in the bottom wall and communicating with the mating port, and the main portion of each contact is accommodated in the corresponding contact groove and the mating portion of the contact extends into the mating port.

6. The cable assembly as claimed in claim 5, further comprising a spacer disposed about a back portion of the insulative housing.

7. The cable assembly as claimed in claim 6, wherein there are a plurality of through holes defined in the spacer to allow the tail portions of the contacts passing therethrough respectively.

8. The cable assembly as claimed in claim 7, wherein the through holes are arranged in a row along a transversal direction.

9. The cable assembly as claimed in claim 6, wherein there is a recess defined in the back portion of the insulative housing to receive the spacer.

10. The cable assembly as claimed in claim 9, wherein there is at least one protrusion formed on a top side of the spacer.

11. A cable assembly comprising:
an insulative housing;
a flat cable having a plurality of wires and an insulative jacket enclosing the wires, the wires arranged in two rows spaced apart from each other along a vertical direction;
a plurality of contacts divided into two rows along the vertical direction, the contacts mounted to the insulative housing, with a tail portion of each contact disposed behind the insulative housing and penetrating into the corresponding wire along an axial direction perpendicular to the vertical direction.

12. The cable assembly as claimed in claim 11, wherein the cable assembly is compatible with HDMI.

13. The cable assembly as claimed in claim 11, further comprising a metallic shell accommodating the insulative housing.

14. The cable assembly as claimed in claim 13, wherein the metallic shell defines a rectangular shaped frame at the back segment thereof.

15. The cable assembly as claimed in claim 14, wherein the tail portions of the contacts extend into the frame.

16. The cable assembly as claimed in claim 15, wherein the frame is inserted into the insulative jacket along the axial direction.

17. A cable assembly comprising:
an insulative housing defining a plurality of passageways and a mating port;
a plurality of contacts disposed in the corresponding passageways, respectively, each of said contacts including a resilient curved mating section exposed in the mating port, and a planar tail section extending rearwardly out of the corresponding passageway, each of said tail section being equipped with a lance configuration thereof;
an insulative spacer disposed behind the housing to seal the corresponding passageways while allowing the tail section to extend therethrough;
a plurality of wires integrated by an outer jacket and side by side arranged in a transverse direction under condition that the tail sections piercing into the corresponding wires, respectively, in an axial direction; and
an insulative outer cover overmolded upon the wire and a part of the housing to protect interconnection between the wires and the contacts.

18. The cable assembly as claimed in claim 17, wherein said housing defines a recess in a rear face to receive said spacer.

19. The cable assembly as claimed in claim 18, wherein the outer jacket terminates at a back face of the spacer.

20. The cable assembly as claimed in claim 17, wherein said contacts define a same configuration in both the corresponding contacting section and tail sections.
